(19) United States
(12) Patent Application Publication
(10) Pub. No.: US 2021/0278242 A1
(43) Pub. Date: Sep. 9, 2021

(54) WEARABLE TERMINAL DISPLAY SYSTEM, WEARABLE TERMINAL DISPLAY METHOD AND PROGRAM

(71) Applicant: OPTIM CORPORATION, Saga (JP)

(72) Inventor: Shunji SUGAYA, Tokyo (JP)

(21) Appl. No.: 16/616,850

(22) PCT Filed: May 26, 2017
(86) PCT No.: PCT/JP2017/019808

§ 371 Date: Nov. 25, 2019

(51) Int. Cl. G01C 21/00; G06F 1/16

(52) U.S. Cl. CPC G01C 21/3885; G01C 21/3848; G06F 1/163

(57) ABSTRACT

Provided is a wearable terminal display system for displaying the guide map of the guidance target on the display board of the wearable terminal. The wearable terminal display system includes: an image acquisition unit for acquiring an image of a guidance target entering a visual field of the wearable terminal; an determination unit for determining the guidance target by performing an image analysis on the image; a collection unit for collecting a guide map of the guidance target; and a guide map display unit for displaying the guide map of the guidance target seen through the display board on the display board of the wearable terminal by using augmented reality.

### TECHNICAL FIELD

The present disclosure relates to a wearable terminal display system, a wearable terminal display method, and a program for displaying a collected guide map of a guidance target seen through a display board of a wearable terminal on the display board of the wearable terminal by using augmented reality.

### BACKGROUND

In recent years, the use of information technology (IT) for guide maps has been increasing. For example, a guidance system that displays a guide map or a map on a mobile phone in conjunction with an integrated circuit (IC) tag is provided (Patent Document 1).

### Existing Art Document

Patent Document
Patent Document 1: Japanese Patent Publication No. JP2005-180967

### SUMMARY

### Problem to be Solved by the Present Disclosure

However, the system of Patent Document 1 has a problem that an IC tag has to be set in order to provide guidance.

In view of the above problem, the present disclosure aims to provide a wearable terminal display system, a wearable terminal display method, and a program, in which a guidance target is determined from an image of a visual field of a wearable terminal, and a guide map collected according to the guidance target is displayed on a display board of a wearable terminal by using augmented reality.

### Solution to the Problem

In the present disclosure, a solution as described below is provided.

According to a first feature, the present disclosure provides a wearable terminal display system for displaying a guide map of a guidance target on a display board of a wearable terminal. The wearable terminal display system includes an image acquisition unit, a determination unit, a collection unit and a guide map display unit. The image acquisition unit is configured to acquire an image of a guidance target entering a visual field of the wearable terminal; the determination unit is configured to perform an image analysis on the image to determine the guidance target; the collection unit is configured to collect a guide map of the guidance target; and the guide map display unit is configured to display the guide map of the guidance target seen through the display board on the display board of the wearable terminal by using augmented reality.

According to the first feature, the present disclosure provides a wearable terminal display method for displaying a guide map of a guidance target on a display board of a wearable terminal. The wearable terminal display method includes: an image acquisition step of acquiring an image of a guidance target entering a visual field of the wearable terminal; a determination step of performing image analysis on the image to determine the guidance target; a collection step of collecting a guide map of the guidance target; and a guide map display step of displaying the guide map of the guidance target seen through the display board on the display board of the wearable terminal by using augmented reality.

According to the first feature, the present disclosure provides a program for causing a computer to execute: an image acquisition step of acquiring an image of a guidance target entering a visual field of a wearable terminal; a determination step of performing an image analysis on the image to determine the guidance target; a collection step of collecting a guide map of the guidance target; and a guide map display step of displaying the guide map of the guidance target seen through the display board on a display board of the wearable terminal by using augmented reality.

### Effect of the Present Disclosure

The guide map of the guidance target can be displayed on the display board of the wearable terminal merely by putting the guidance target in the visual field of the wearable terminal.

### BRIEF DESCRIPTION OF DRAWINGS

FIG. 1 is a schematic diagram of a wearable terminal display system.

FIG. 2 is an example in which a guide map of a guidance target is collected and displayed on a display board of a wearable terminal.

### DETAILED DESCRIPTION

Hereinafter, the best preferred embodiment of the present disclosure will be described. It should be noted that this is merely an example, and the technical scope of the present disclosure is not limited thereto.

The wearable terminal display system of the present disclosure is a system for displaying a collected guide map of a guidance target seen through the display board on a display board of a wearable terminal by using augmented reality. A wearable terminal refers to a terminal having a visual field, such as smart glass, a head mounted display, etc.

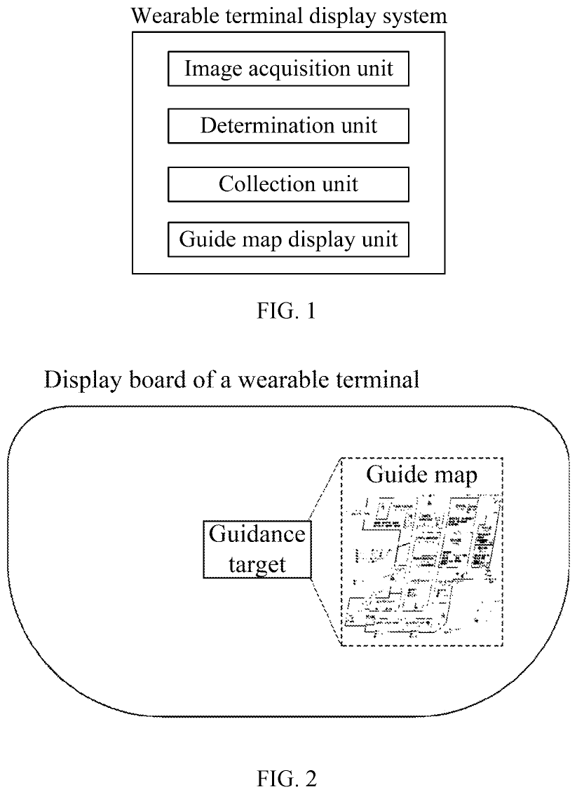

A preferred embodiment of the present disclosure is described according to FIG. 1. FIG. 1 is a schematic diagram of a wearable terminal display system in the preferred embodiment of the present disclosure.

As shown in FIG. 1, the wearable terminal display system includes an image acquisition unit, a determination unit, a collection unit, and a guide map display unit, which are implemented by reading a predetermined program through a control section. In addition, although not shown, a determination unit, a change unit, a detection unit, an action result display unit, a position and direction acquisition unit, an estimating unit, a guideline display unit, and a selection acceptance unit may also be provided. These units may be of application-type, cloud-type, or other types. The various units described above may be implemented by an independent computer or by more than two computers (e.g., as in the case of servers and terminals).

The image acquisition unit acquires an image of a guidance target entering the visual field of the wearable terminal, and may also acquire an image taken by the camera of the wearable terminal. In addition, it is acceptable even if it is other than the wearable terminal as long as the image as described above can be acquired. The image may be a moving image or a still image. In order to display the guide map in real time, a real-time image is preferable.

The determination unit performs an image analysis on the image to determine a guidance target, for example, to determine whether the guidance target is a specific store name (e.g., Isetan, Marui, or Mitsui Outlet Park). A guidance target may, but may not necessarily, be identified from appearance, a signboard, or a logo mark. In addition, if it is time-consuming to determine all of the guidance targets mapped, merely the guidance target in the center of the visual field of the wearable terminal may be identified. If merely the guidance target in the center of the visual field is identified, the time required for the identification can be greatly reduced. The accuracy of image analysis can also be improved through machine learning. For example, machine learning is performed by using a past image of a guidance target as teacher data.

The collection unit collects a guide map corresponding to the guidance target. The guide map corresponding to the guidance target may also be collected according to a database in which the guide map is registered in advance. In addition, the guide map may also be collected by accessing Web content associated with the guidance target in advance, for example, be collected from Web content by assigning a uniform resource locator (URL) or the like that associates a guide map with a guidance target. In addition, Internet retrieval may be performed on a guidance target to collect the guide map from the retrieved Web content. For example, a case exists where the guide map is loaded on a home page of the guidance target, and thus collection can be performed through Internet retrieval. In addition, the guide map can be collected from a social networking service (SNS), a word-of-mouth site, and the like.

The guide map display unit displays the guide map of a guidance target seen through the display board on the display board of the wearable terminal by using augmented reality. For example, as shown in FIG. 2, for the guidance target seen through the display board of the wearable terminal and depicted by the solid line, the guide map depicted by the dashed line is displayed on the display board of the wearable terminal by using augmented reality. For ease of understanding, the solid line is provided as a real object and the dashed line is provided as augmented reality. The guide map of the guidance target seen through the display board and depicted by the solid line is displayed as augmented reality, and therefore, it is possible to visually grasp what kind of guide map the guidance target has. Although the guide map displayed by using the augmented reality may be displayed in a manner of overlapping the guidance target seen through the display board, it becomes difficult to see the guidance target, and therefore, it is also possible to switch ON/OFF the display of the guide map.

The judgment unit determines whether the displayed guide map is browsed. Whether the guide map is browsed may be judged by acquiring the image being browsed and performing an image analysis. In addition, whether the guide map is browsed may also be determined based on the information of a sensor of the wearable terminal, information of the sensor worn on the viewer, etc., for example, sensors include a sensor for sensing line of sight, a motion sensor, an acceleration sensor, and the like.

The change unit changes the guide map to “browsed” in condition that the guide map is determined to have been browsed, and changes the degree of attention in condition that the guide map is determined not to have been browsed so that the guide map is to be browsed. In this way, it is possible to visually grasp which guide map has or has not been browsed. For example, it may be determined that the guide map has been browsed by checking the checkbox of the guide map. For example, it may be determined that the guide map has been browsed by pressing a stamp on the guide map. In addition, the degree of attention may be changed by changing the color and size of the guide map or by pressing a stamp so that the guide map is conspicuous.

The detection unit detects an action on the displayed guide map. The action is, for example, a gesture, movement of the hand, movement of the line of sight, etc. The image being viewed is acquired and subjected to image analysis, so that the action on the guide map can be detected. In addition, the action on the guide map may also be detected according to information of a sensor of the wearable terminal, information of the sensor worn on the viewer, etc., for example, sensors include a sensor for sensing line of sight, a motion sensor, an acceleration sensor, etc.

The action result display unit displays the result corresponding to the action about the guidance target seen through the display board of the wearable terminal on the display board of the wearable terminal by using augmented reality. For example, if an action of canceling the guide map is detected, the display of the guide map is canceled. For example, if an action of opening the link attached to the guide map is detected, the link is opened. Other actions are of course possible.

The position and direction unit acquires a terminal position and a photographing direction of the wearable terminal. For example, the terminal position can be acquired from a global positioning system (GPS) of the wearable terminal. For example, in the case of photographing through the wearable terminal, the photographing direction can be acquired from the geomagnetic sensor and the acceleration sensor of the wearable terminal. Acquisition may also be performed in other manners.

The estimating unit estimates the position of the guidance target based on the terminal position and the photographing direction. If the terminal position and the photographing direction are known, the position of the photographed guidance target can be predicted.

In addition, the determination unit may determine the guidance target according to the position of the guidance target and the image analysis. For example, a case exists where a guidance target is the same chain store but the guide map differs depending on the store, so it may not be possible to uniquely determine the position of the guidance target without predicting the position of the guidance target. For example, if it can be identified that the store is a Minato-ku store in Tokyo, a guide map of the Minato-ku store in Tokyo can be displayed.

The guideline display unit displays a guideline for photographing the guidance target on the display board of the wearable terminal by using augmented reality. For example, guidelines such as a frame and a cross may be displayed. Image analysis is facilitated with photographing along the guideline.

In addition, the acquisition unit may acquire an image taken along the guideline. The guidance target can be efficiently determined by acquiring merely the image taken along the guideline and performing image analysis.

The selection acceptance unit accepts the selection of a selection target about a guidance target seen through the display board of the wearable terminal. For example, the selection of the selection target may be accepted through observation of a guidance target seen through the display board of the wearable terminal for a certain time. For example, the selection of the selection target may also be accepted by touching a guidance target seen through the display board of the wearable terminal. For example, the selection of the selection target may also be accepted by placing a cursor on a guidance target seen through the display board of the wearable terminal. For example, sensors include a sensor for sensing line of sight, a motion sensor, an acceleration sensor, etc.

In addition, it is also possible that the guide map matched merely with the selection target seen through the display board is displayed on the display board of the wearable terminal by using augmented reality. The guide map matched merely with the selection target seen through the display board is displayed as augmented reality, so the guide map can be grasped at a pinpoint. When guide maps about all identified guidance targets are displayed, the screen of the display board may be cumbersome.

(Description of Operation)

A wearable terminal display method is described below. The wearable terminal display method of the present disclosure is a method for displaying a collected guide map of a guidance target seen through a display board of a wearable terminal on the display board of the wearable terminal by using augmented reality.

The wearable terminal display method includes an image acquisition step, a determination step, a collection step, and a guide map display step. In addition, although not shown, a judgment step, a change step, a detection step, an action result display step, a position and direction acquisition step, an estimation step, a guideline display step, and a selection acceptance step may also be provided.

In the image acquisition step, an image of a guidance target entering the visual field of the wearable terminal is acquired, and an image taken by the camera of the wearable terminal may also be acquired. In addition, it is acceptable even if it is other than the wearable terminal as long as the image as described above can be acquired. The image may be a moving image or a still image. In order to display the guide map in real time, a real-time image is preferable.

In the determination step, image analysis is performed on the image to determine a guidance target, for example, to determine whether the guidance target is a specific store name (e.g., Isetan, Marui, or Mitsui Outlet Park, etc.). A guidance target may, but may not necessarily, be identified from appearance, a signboard, or a logo mark. In addition, if it is time-consuming to determine all of the guidance targets mapped, merely the guidance target in the center of the visual field of the wearable terminal may be identified. If merely the guidance target in the center of the visual field is determined, the time required for the determination can be greatly reduced. The accuracy of image analysis can also be improved through machine learning. For example, machine learning is performed by using a past image of a guidance target as teacher data.

In the collection step, a guide map corresponding to the guidance target is collected. The guide map corresponding to the guidance target may also be collected according to a database in which the guide map is registered in advance. In addition, the guide map may also be collected by accessing Web content associated with the guidance target in advance, for example, be collected from Web content by assigning a URL or the like that associates a guide map with a guidance target. In addition, Internet retrieval may be performed on a guidance target to collect the guide map from the retrieved Web content. For example, a case exists where the guide map is loaded on a home page of the guidance target, and thus collection can be performed through Internet retrieval. In addition, the guide map can be collected from a social networking service (SNS), a word-of-mouth site, and the like.

In the guide map display step, the guide map of a guidance target seen through the display board is displayed on the display board of the wearable terminal by using augmented reality. For example, as shown in FIG. 2, for the guidance target seen through the display board of the wearable terminal and depicted by the solid line, the guide map depicted by the dashed line is displayed on the display board of the wearable terminal by using augmented reality. For ease of understanding, the solid line is provided as a real object and the dashed line is provided for augmented reality. The guide map of the guidance target seen through the display board and depicted by the solid line is displayed by using augmented reality, and therefore, it is possible to visually grasp what kind of guide map the guidance target has. Although the guide map displayed as the augmented reality may be displayed in a manner of overlapping the guidance target seen through the display board, it becomes difficult to see the guidance target, and therefore, it is also possible to switch ON/OFF the display of the guide map.

In the judgment step, it is judged whether the displayed guide map is browsed. Whether the guide map is browsed may be judged by acquiring the image being browsed and performing an image analysis. In addition, whether the guide map is browsed may also be judged based on the information of a sensor of the wearable terminal, information of a sensor worn on the viewer, etc., for example, sensors include a sensor for sensing line of sight, a motion sensor, an acceleration sensor, and the like.

In the change step, the guide map is changed to “browsed” in condition that the guide map is determined to have been browsed, and the degree of attention is changed in condition that the guide map is determined not to have been browsed so that the guide map is to be browsed. In this way, it is possible to visually grasp which guide map has or has not been browsed. For example, it may be determined that the guide map has been browsed by checking the checkbox of the guide map. For example, it may be determined that the guide map has been browsed by pressing a stamp on the guide map. In addition, the degree of attention may be changed by changing the color and size of the guide map or by pressing a stamp so that the guide map is conspicuous.

In the detection step, an action on the displayed guide map is detected. The action is, for example, a gesture, movement of the hand, movement of the line of sight, etc. The image being browsed is acquired and subjected to image analysis, so that the action on the guide map can be detected. In addition, the action on the guide map may also be detected according to information of a sensor of the wearable terminal, information of the sensor worn on the viewer, etc., for example, sensors include a sensor for sensing line of sight, a motion sensor, an acceleration sensor, etc.

In the action result display step, the result corresponding to the action about the guidance target seen through the display board of the wearable terminal is displayed on the display board of the wearable terminal by using augmented reality. For example, if an action of canceling the guide map is detected, the display of the guide map is canceled. For example, if an action of opening the link attached to the guide map is detected, the link is opened. Other actions are of course possible.

In the position and direction step, a terminal position and a photographing direction of the wearable terminal are acquired. For example, the terminal position can be acquired from a global positioning system (GPS) of the wearable terminal. For example, in the case of photographing through the wearable terminal, the photographing direction can be acquired from the geomagnetic sensor and the acceleration sensor of the wearable terminal. Acquisition may also be performed in other manners.

In the estimation step, the position of the guidance target is estimated based on the terminal position and the photographing direction. If the terminal position and the photographing direction are known, the position of the photographed guidance target can be estimated.

In addition, in the determination step, the guidance target may be determined according to the position of the guidance target and the image analysis. For example, a case exists where a guidance target is the same chain store but the guide map differs depending on the store, so it may not be possible to uniquely determine the position of the guidance target without predicting the position of the guidance target. For example, if it can be identified that the store is a Minato-ku store in Tokyo, a guide map of the Minato-ku store in Tokyo can be displayed.

In the guideline display step, a guideline for photographing the guidance target is displayed on the display board of the wearable terminal by using augmented reality. For example, guidelines such as a frame and a cross may be displayed. Image analysis is facilitated with photographing along the guideline.

In addition, in the acquisition step, an image taken along the guideline may be acquired. The guidance target can be efficiently determined by acquiring merely the image taken along the guideline and performing image analysis.

In the selection acceptance step, the selection of a selection target about a guidance target seen through the display board of the wearable terminal is accepted. For example, the selection of the selection target may be accepted through observation of a guidance target seen through the display board of the wearable terminal for a certain time. For example, the selection of the selection target may also be accepted by touching a guidance target seen through the display board of the wearable terminal. For example, the selection of the selection target may also be accepted by placing a cursor on a guidance target seen through the display board of the wearable terminal. For example, sensors include a sensor for sensing line of sight, a motion sensor, an acceleration sensor, etc.

In addition, in the guide map display step, it is also possible that the guide map matched merely with the selection target seen through the display board is displayed on the display board of the wearable terminal by using augmented reality. The guide map matched merely with the selection target seen through the display board is displayed by using augmented reality, so the guide map can be grasped at a pinpoint. When guide maps about all identified guidance targets are displayed, the screen of the display board may be cumbersome.

The above-mentioned units and functions are implemented by a computer (including a central processing unit (CPU), an information processing apparatus, and various terminals) reading and executing a predetermined program. The program may be, for example, an application installed in the computer, may be in a form of Software as a Service (SaaS) provided from the computer via a network, or may be recorded on a computer-readable recording medium such as a floppy disk, a Compact Disc (CD) (including a CD-Read Only Memory (CD-ROM), etc.), a Digital Versatile Disc (DVD) (including a DVD-ROM, a DVD-Random Access Memory (DVD-RAM), etc.), etc. In this case, the computer reads the program from the recording medium, transmits the program to an internal storage apparatus or an external storage apparatus for storage and execution. Further, the program may also be pre-recorded, for example, on a storage apparatus (recording medium) such as a magnetic disk, an optical disk, a magneto-optical disk, or the like, and is supplied from the storage apparatus to the computer via a communication line.

As the specific algorithm of the above-mentioned machine learning, a nearest neighbor method, a Naive Bayes method, a decision tree, a support vector machine, and reinforcement learning may be used. Further, deep learning using a neural network to generate a feature quantity for learning by itself is also possible.

The embodiments of the present disclosure have been described above, but the present disclosure is not limited to the above-mentioned embodiments. In addition, the effects described in the embodiments of the present disclosure are merely illustrative of the best effects produced by the present disclosure, and the effects of the present disclosure are not limited to the effects described in the embodiments of the present disclosure.

1. A wearable terminal display system for displaying a guide map of a guidance target on a display board of a wearable terminal, comprising:
an image acquisition unit, which is configured to acquire an image of a guidance target entering a visual field of the wearable terminal;
a determination unit, which is configured to perform an image analysis on the image to determine the guidance target;
a collection unit, which is configured to collect a guide map of the guidance target; and
a guide map display unit, which is configured to: display the guide map of the guidance target seen through the display board on the display board of the wearable terminal by using augmented reality.

2. The wearable terminal display system of claim 1, wherein
the determination unit is configured to merely determine a guidance target located in a center of the visual field of the wearable terminal.

3. The wearable terminal display system of claim 1, wherein
the collection unit is configured to collect the guide map of the guidance target according to a database in which the guide map is registered in advance.

4. The wearable terminal display system of claim 1, wherein
the collection unit is configured to access World Wide Web (web) content associated with the guidance target in advance to collect the guide map.

5. The wearable terminal display system of claim 1, wherein
the collection unit is configured to perform Internet retrieval of the guidance target to collect the guide map from retrieved Web content.

6. The wearable terminal display system of claim 1, comprising:
a judgment unit, which is configured to determine whether the displayed guide map is browsed; and
a change unit, which is configured to change the guide map to a browsed state in response to determining that the guide map is browsed.

7. The wearable terminal display system of claim 1, comprising:
a judgment unit, which is configured to judge whether the displayed guide map is browsed; and
a change unit, which is configured to change a degree of attention in response to determining that the guide map is not browsed so that the guide map is to be browsed.

8. The wearable terminal display system of claim 1, comprising:
a detection unit, which is configured to detect an action on the displayed guide map; and
an action result display unit, which is configured to display a result corresponding to the action about the guidance target seen through the display board on the display board of the wearable terminal by using the augmented reality.

9. The wearable terminal display system of claim 1, comprising:
a position and direction acquisition unit, which is configured to acquire a terminal position and a photographing direction of the wearable terminal; and
an estimating unit, which is configured to estimate a position of the guidance target based on the terminal position and the photographing direction;
wherein the determination unit is configured to determine the guidance target according to the position of the guidance target and the image analysis.

10. The wearable terminal display system of claim 1, comprising:
a guideline display unit, which is configured to display a guideline for photographing the guidance target on the display board of the wearable terminal by using the augmented reality;
wherein the acquisition unit is configured to acquire the image photographed along the guideline.

11. The wearable terminal display system of claim 1, comprising:
a selection acceptance unit, which is configured to accept a selection of a selection target about the guidance target seen through the display board of the wearable terminal;
wherein the guide map display unit is configured to display a guide map matched merely with the selection target seen through the display board on the display board of the wearable terminal by using the augmented reality.

12. A wearable terminal display method for displaying a guide map of a guidance target on a display board of a wearable terminal, comprising:
an image acquisition step of acquiring an image of a guidance target entering a visual field of the wearable terminal;
an determination step of performing an image analysis on the image to determine the guidance target;
a collection step of collecting a guide map of the guidance target; and
a guide map display step of displaying the guide map of the guidance target seen through the display board on the display board of the wearable terminal by using augmented reality.

13. A non-transitory computer-readable program, which is configured for causing a wearable terminal display system to execute:
an image acquisition step of acquiring an image of a guidance target entering a visual field of a wearable terminal;
a determination step of performing image analysis on the image to determine the guidance target;
a collection step of collecting a guide map of the guidance target; and
a guide map display step of displaying the guide map of the guidance target seen through the display board on a display board of the wearable terminal by using augmented reality.
